(19) United States
(12) Patent Application Publication
(10) Pub. No.: US 2025/0166087 A1
(43) Pub. Date: May 22, 2025

(54) INFORMATION PROCESSING SYSTEM AND PROGRAM

(71) Applicant: HAPPINESS PLANET, LTD., Tokyo (JP)

(72) Inventors: Yuki OTA, Tokyo (JP); Koji ARA, Tokyo (JP); Kazuo YANO, Tokyo (JP); Satomi TSUJI, Tokyo (JP)

(21) Appl. No.: 18/839,766

(22) PCT Filed: Mar. 2, 2022
(86) PCT No.: PCT/JP2022/008811

§ 371 Date: Aug. 20, 2024

(51) Int. Cl. G06Q 50/00; G06Q 10/107

(52) U.S. Cl. CPC G06Q 50/01; G06Q 10/107

(57) ABSTRACT

An information processing system includes a processing unit and a storage unit. The storage unit stores a plurality of user IDs specifying a plurality of respective users, and the processing unit performs: group generation processing of assigning each of the plurality of user IDs to a group on the basis of a predetermined reference value; display of a timeline according to the group and the user ID; and display of information representing a user related to the user ID and a comment input field for receiving an input comment together with the timeline.

### TECHNICAL FIELD

The present invention relates to an information processing system and a program. For example, the present invention relates to a system that supports communication within an organization. The present invention also relates to, e.g., a technology that promotes non-face-to-face communication.

### BACKGROUND ART

In recent years, attention has been focused on labor-related issues in companies or the like, and not only financial soundness of a company, but also the fact that the company is managed with employees thereof in a healthy state, both mentally and physically, have been increasingly evaluated by society as values of the company. Among factors that keep the employees in the healthy state, there is communication between the employees.

Promotion of communication is a factor inevitable to building a trust relationship between people, and is particularly important in a company, since the promotion of communication is also related to improving productivity and preventing employee turnover. However, with the spread of remote work in recent years, communication in a face-to-face state has decreased, while online non-face-to-face communication has increased.

Non-face-to-face communication is less likely to occur incidentally than face-to-face communication, and a communication partner is mostly chosen with a certain degree of communication purpose in mind. Therefore, while contact with work-related immediate superiors and concerned parties is likely to occur, opportunities for conversation with less-work-related colleagues at work, casual conversation that is less related to work, and the like tend to be lost.

Companies need to increase communication between employees and reduce the number of lonely or anxious employees to keep the employees in a healthy state. As a means to this end, an increasing number of companies have promoted introduction of a SNS (Social Networking Service) into the companies or the like. By introducing the SNS, a user can post and share information or the like with the entire organization, and other participants view and comment on the posted information, which is expected to promote cross-organizational communication. Therefore, it is important to activate the use of the SNS by employees, and related inventions have been made also in general SNS.

For example, from the viewpoint of activating actions such as commenting. Patent Literature 1 visualizes and displays information on a quantity of actions between users on a SNS to allow the users to recognize the quantity of actions thereof and promote actions or suppress excessive actions. Meanwhile, for example, from a viewpoint of allowing effective acquisition of information, in Patent Literature 2, a user who displays comments and a user who does not display comments are determined and filtered on the basis of a degree of relevance between the users.

### CITATION LIST

### Patent Literature

Patent Literature 1: Japanese Patent No. 6798958
Patent Literature 2: Japanese Unexamined Patent Application Publication No. 2014-154003

### SUMMARY OF INVENTION

### Technical Problem

When consideration is given to the use of SNS within a company, mere visualization of a quantity of actions and filtering of users does not necessarily promote cross-organizational communication.

First, in an organization such as a company, it is desirable that people in managerial positions, who are expected to support the organization, actively comment on employee posts. However, managers are generally busy with daily work and, as a size of the organization is larger, the number of employees to be supported is larger, and therefore it is burdensome for the managers to make comments alone. Meanwhile, when non-managerial veteran employees provide support instead, there is a high psychological hurdle in commenting to less-work-related colleagues, which may result in a decision-making burden in deciding to whom to comment, or there is a risk that comments may be concentrated on some of the employees.

Next, people who need support, such as subordinates and newcomers, may not receive sufficient support from superiors or veteran employees for the reasons described above, which may lead to problems such as isolation within the organization and difficulty in building good relationships with understanding people. Recognition of few comments from others on own posts leads to a vicious cycle of further suppression of communication due to an unfulfilled sense of belonging to the organization and unsatisfied self-esteem needs.

As described above, when it is attempted to activate the use of a SNS in an organization such as a company, mere visualization of a quantity of actions and filtering of the users will only arbitrarily control people who send or display comments and may encourage bias, such as concentration of communication only between specific people. In order to promote cross-organizational communication, it is necessary to equally activate communication throughout the entire organization, while activating communication by each one of the employees.

It is therefore an object of the present invention to efficiently promote communication and eliminate bias in the entire organization by allowing any user to easily receive comments from other users, while reducing a burden of making comments.

### Solution to Problem

One example of an information processing system according to the present invention is an information processing system including a processing unit and a storage unit, the storage unit stores a plurality of user IDs specifying a plurality of respective users, and the processing unit performs: group generation processing of assigning each of the plurality of user IDs to a group on the basis of a predetermined reference value; display of a timeline according to the group and the user ID; and display of information representing a user related to the user ID and a comment input field for receiving an input comment together with the timeline.

The one example of a program according to the present invention causes a computer to function as the above-mentioned information processing system.

### Advantageous Effects of Invention

Accordingly to the present invention, it is possible to efficiently promote cross-organizational communication by eliminating communication bias within an organization, while activating communication by a user.

### BRIEF DESCRIPTION OF DRAWINGS

FIG. 1 is a diagram illustrating an entire configuration and functions of a communication promotion system in a first embodiment of the present invention.

FIG. 2 is a conceptual diagram illustrating an overview of assignment of users to groups in the first embodiment of the present invention.

FIG. 3 is a sequence diagram illustrating an overview of overall processing when the communication promotion system is used in the first embodiment of the present invention.

FIG. 4 is a diagram illustrating an example of a user table in the first embodiment of the present invention.

FIG. 5 is a diagram illustrating an example of a tenant table in the first embodiment of the present invention.

FIG. 6 is a diagram illustrating an example of a posting history table in the first embodiment of the present invention.

FIG. 7 is a diagram illustrating an example of an action history table in the first embodiment of the present invention.

FIG. 8 is a diagram illustrating an example of display on a screen of an application to be used by an administrator when inputting group settings in the first embodiment of the present invention.

FIG. 9 is a flow chart illustrating an example of processing performed in a group setting reception unit of a management server in the first embodiment of the present invention.

FIG. 10 is a diagram illustrating an example of a group setting table in the first embodiment of the present invention.

FIG. 11 is a diagram illustrating an example of external relation data in the first embodiment of the present invention.

FIG. 12 is a flow chart illustrating an example of processing performed in a group management unit of the management server in the first embodiment of the present invention.

FIG. 13 is a diagram illustrating an example of a group table in the first embodiment of the present invention.

FIG. 14 is a diagram illustrating an example of a group member table in the first embodiment of the present invention.

FIG. 15 is a flow chart illustrating an example of processing performed in a UI provision unit of the management server in the first embodiment of the present invention.

FIG. 16 is a diagram illustrating an example of display on a client screen in the first embodiment of the present invention.

FIG. 17 is a diagram illustrating an example of display on a screen of an application to be used by the administrator when checking a group setting situation in the first embodiment of the present invention.

FIG. 18 are diagrams illustrating an example of display of electronic mails in the first embodiment of the present invention.

### DESCRIPTION OF EMBODIMENTS

### First Embodiment

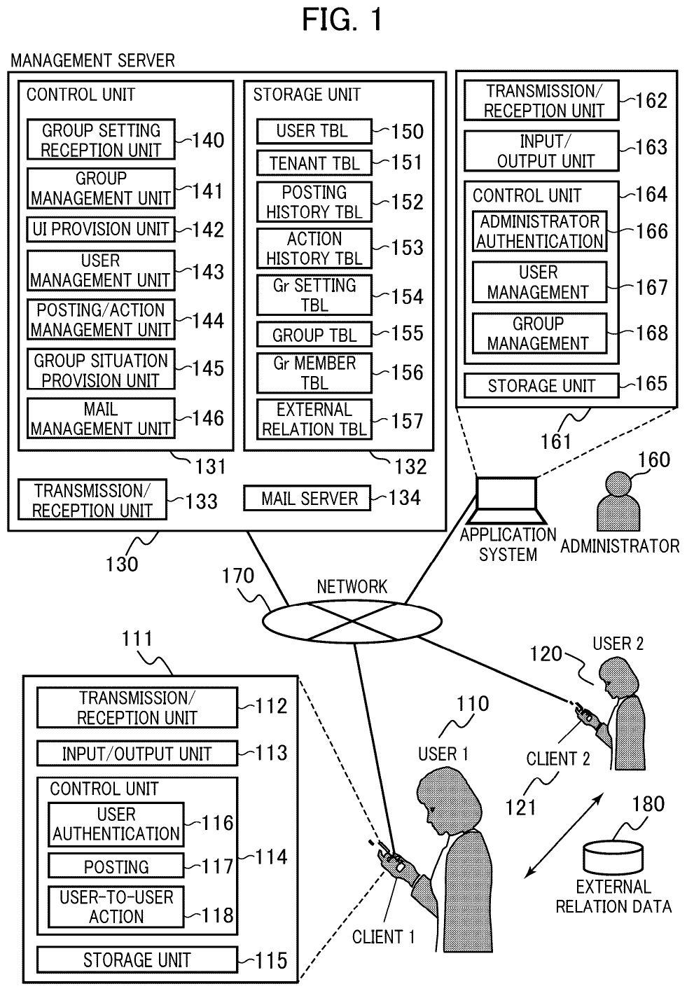

FIG. 1 is a diagram illustrating an entire configuration and functions of an SNS-type communication promotion system. Each of the functions in the drawing is implemented by cooperation between hardware and software. A description is given herein of an overview of the system, while details of each of the functions and the like will be described later using another drawing.

The SNS-type communication promotion system is an information processing system including a client 111 operated by a user 110, an application system 161 operated by an administrator 160, and a management server 130 connectable to each of the client 111 and the application system 161 via a wireless or wired network 170.

Note that FIG. 1 illustrates a user 120 and a client 121, and a plurality of users can be connected to the network 170 by operating the different clients. The following description related to the user 110 and the client 111 is common also to the user 120 and the client 121 unless otherwise specified, and is further common also to another user and another client each not shown.

The client 111 is a typical smartphone, PC terminal, or the like and includes a transmission/reception unit 112, an input/output unit 113, a control unit 114, and a storage unit 115. The transmission/reception unit 112 is configured to include a network interface of a wired, wireless, or another type. The input/output unit 113 transmits/receives information to/from the user and is configured to include an input/output device such as, e.g., a screen, a touch panel, or a keyboard. The control unit 114 is configured to include a central processing unit (CPU), which is a processing unit such as a typical computer. It can be said that processing in each computer described in the present description is performed by a processing unit thereof. Meanwhile, the storage unit 115 is configured to include a memory device such as a semiconductor storage device or a magnetic storage device.

The control unit 114 has a user authentication function 116, a posting function 117, and a user-to-user action function 118, which are implemented by execution of a predetermined program held by the storage unit 115. Using a means such as a password request, the user authentication function 116 authenticates whether or not the user is a person registered in advance and allows login when the authentication is successful and, after successful login, a user ID is held by the storage unit 115.

The posting function 117 transmits data input by the user 110 by operating the input/output unit 113 to the management server 130 via the transmission/reception unit 112 to allow a posting activity by the user on a SNS. The user-to-user action function 118 is similarly such that the user 110 operates the input/output unit 113 to perform an action, such as “like” or “comment”, on a post made by another user or the like and transmits the data to the management server 130 to implement communication with the other user on the SNS.

The management server 130 includes a control unit 131, a storage unit 132, a transmission/reception unit 133, and a mail server 134. The control unit 131 configured to include a typical CPU or the like includes a group setting reception unit 140, a group management unit 141, a UI provision unit 142, a user management unit 143, a posting/action management unit 144, a group situation provision unit 145, and a mail management unit 146. These are implemented by the control unit 131 by executing a predetermined program stored in the storage unit 132 configured to include a memory device or the like.

A database in the storage unit 132 has a user table 150, a tenant table 151, a posting history table 152, an action history table 153, a group setting table 154, a group table 155, a group member table 156, and an external relation table 157. Data exchange between the client 111 and the application system 161 is performed via the transmission/reception unit 133 configured to include a network interface.

The user management unit 143 receives user information input by the administrator 160 from the application system 161 and stores the user information in the user table 150. The posting/action management unit 144 receives information items related to posting and actions input by the user 110 from the client 111 and individually stores the information items in the posting history table 152 and the action history table 153.

The group setting reception unit 140 receives, from the application system 161, group settings (settings of, e.g., the number of constituent members, schedules, and the like related to each of groups) input by the administrator 160 and stores and registers the group settings in the group setting table 154. On the basis of the stored setting data, the group management unit 141 determines assignment of a target user group to the groups and stores the assignment in the group table 155 and the group member table 156.

The UI provision unit 142 receives the user ID and a screen display request from the client 111 and displays a timeline dedicated to the group to which the user 110 belongs on a screen of the client 111. Due to these basic configurations, the target user group is periodically assigned to the groups on the basis of the number of constituent members, schedules, and the like set by the administrator 160, and is presented as targeted people supposed to send comments to each other.

By using the information stored in the group member table 156 and the action history table 153, the group management unit 141 can also determine the group assignment in consideration of previous group assignment and a quantity of user-to-user actions. Alternatively, the group assignment may also be determined in consideration of relationships or an amount of communication among the users outside the system, and it may also be possible to use, e.g., an electronic mail transmission/reception history or a chat history obtainable from a PC or cellular phone log, face-to-face information acquired by a device such as a sensor device or the like. These information items are prepared as external relation data 180 and stored in the external relation table 157 of the management server 130 by the administrator 160 by operating the application system 161 to be usable for the group assignment.

The group situation provision unit 145 receives the screen display request from the application system 161 to aggregate the information items stored in the group member table 156 and the action history table 153 and displays information such as a member composition and the number of comments of each group on a screen of the application system 161. The mail management unit 146 aggregates the member compositions and posting situations on the basis of the information stored in the group member table 156 and the posting history table 152, and delivers electronic mails to mail addresses associated with the target users via the mail server 134. Note that it may also be possible to allow the user 110 to view the electronic mails by using the client 111.

The application system 161 is a system to be used by the administrator 160 to manage the users and the group settings. The application system 161 is a typical PC terminal or the like. The application system 161 includes a transmission/reception unit 162 configured to include a network interface, an input/output unit 163 configured to include a screen, a keyboard, and the like, a control unit 164 configured to include a CPU or the like, and a storage unit 165 configured to include a memory device or the like.

The control unit 164 has an administrator authentication function 166, a user management function 167, and a group management function 168, which are implemented by execution of a predetermined program held by the storage unit 165. The administrator authentication function 166 authenticates whether or not the administrator is a person registered in advance by using a means such as a password request and allows login when the authentication is successful and, after the successful login, an administrator ID is held by the storage unit 165.

The user management function 167 uses the transmission/reception unit 162 to transmit data input by the administrator 160 by operating the input/output unit 163 to the management server 130 and thereby allow the user to be managed by registering the user in advance or giving a predetermined label to the user. The group management function 168 similarly uses the transmission/reception unit 162 to transmit data input by the administrator 160 by operating the input/output unit 163 to the management server 130 and thereby allow the numbers of constituent members, schedules, and the like of the groups to be set or allow a group assignment situation to be viewed.

Thus, the management server 130, the client 111, and the application system 161 have respective hardware configurations as known computers, and include the respective control units and storage units. The control units includes the processing units to control the computers. The storage units stores respective programs, and the processing units execute the respective corresponding programs to allow the respective computers to function as the management server 130, the client 111, and the application system 161. In other words, the individual programs cause the respective corresponding computers to cooperate and function as the communication promotion system.

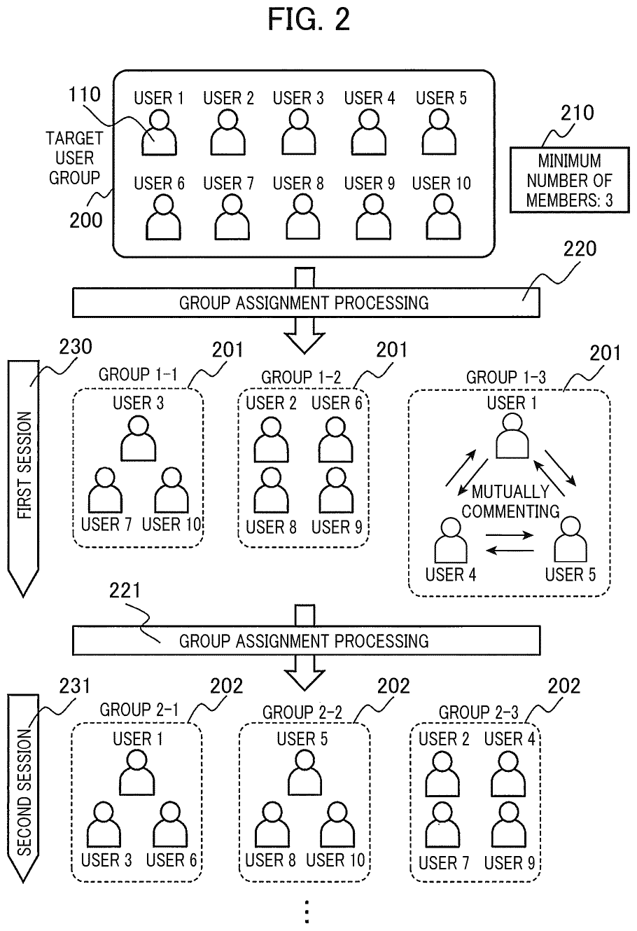

FIG. 2 is a diagram illustrating, as an overview, an example in which the users are grouped in the communication promotion system. A target user group 200 represents the target users to be assigned to the groups, which is a group including a plurality (e.g., a given number or more) of the users. The target user group 200 is a target for which communication is to be promoted, and may also form a company, a community, an organization, or the like aiming at activating exchange of comments or the like between the individual users and building a network of equal communication which is not concentrated only between some of the users. By way of example, 10 users are illustrated.

Each of the users in the target user group 200 is assigned to each of the groups by group assignment processing 220 (group generation processing) on the basis of information set by the administrator 160. The number of the groups can be determined to be a value such that, by setting, e.g., a minimum number of members 210 per group, the number of members belonging to each of the groups is not less than a minimum value and the number of the groups is maximized. The example in FIG. 2 corresponds to a case where the minimum number of members 210 is set to “3”, and the 10 users are assigned to three groups 201.

In a small-group environment in which communication is not possible without constant participation by each group member, each group member tends to feel psychological pressure to make a comment while, conversely, in a group including a large number of members, each group member may become reluctant to communicate and feel burdened by commenting, and therefore it is important to control the number of members of a group. By setting a minimum value, it is possible to ensure that each group has the minimum number of members necessary for smooth communication and, at the same time, by maximizing the number of groups, it is possible to prevent the number of members belonging to each group from becoming excessively large.

In addition, since the administrator 160 can think and set an appropriate number of members which allows easy communication between the users irrespective of a size of the target user group 200, specifying a minimum value allows the administrator 160 to more easily make a determination rather than merely specifying the number of the groups. Note that, practically, it is desirable to set the minimum value within a range of three to five as an appropriate number of members which allows easy communication.

The users assigned to the same group recognize each other as targeted people who are supposed to comment on respective posts made thereby. After a lapse of a given period, the group ends an activity, and the members are assigned again to new groups 202 by group assignment processing 221 (group generation processing). In the present embodiment, the given period during which the group does the activity is referred to as a first session 230 or a second session 231. A period of each of the sessions can be set to, e.g., one week or the like, and can be set in advance by the administrator 160. The number of times each of the sessions is to be repeated can similarly be set by the administrator 160.

By thus causing the users to belong to the groups each including an appropriate number of members which allow easy communication therebetween, it can be expected that any user easily obtains a given number or more of comments. In addition, since the targeted people supposed to comment on are automatically determined and the number of the targeted people is small, the burden of commenting is also reduced, and promotion of communication within the group can be expected. Furthermore, by periodically changing a composition of each of the groups, it is possible to eliminate bias in a communication network between the users and help build cross-organizational human relations in the organization.

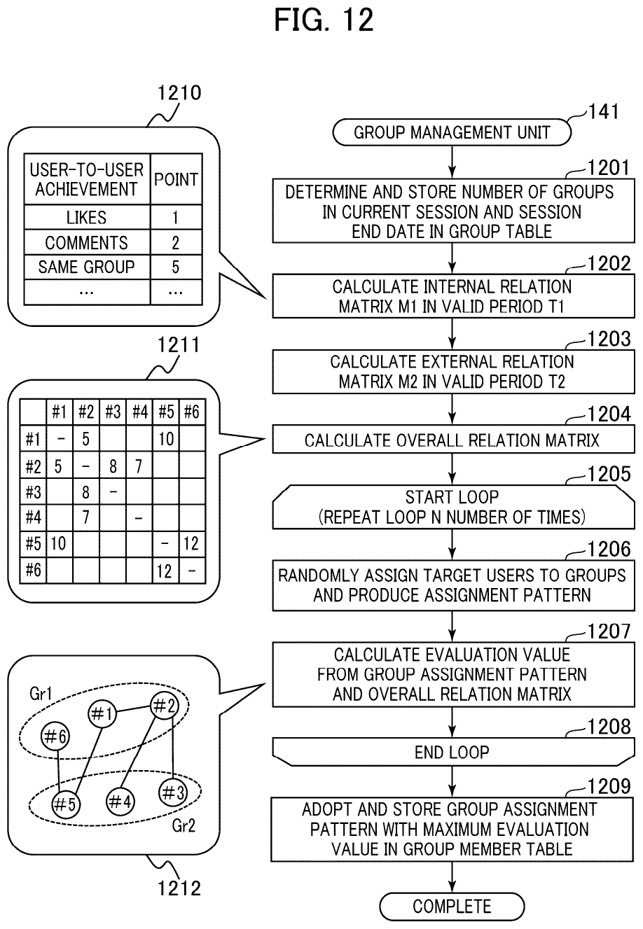

Additionally, as will be described later with reference to FIG. 12, by considering information such as a most recent group member composition and a quantity of comments in the group assignment processing, activation and equalization of communication in the organization is more efficiently implemented through prioritized assignment of the users having little communication therebetween to the same group.

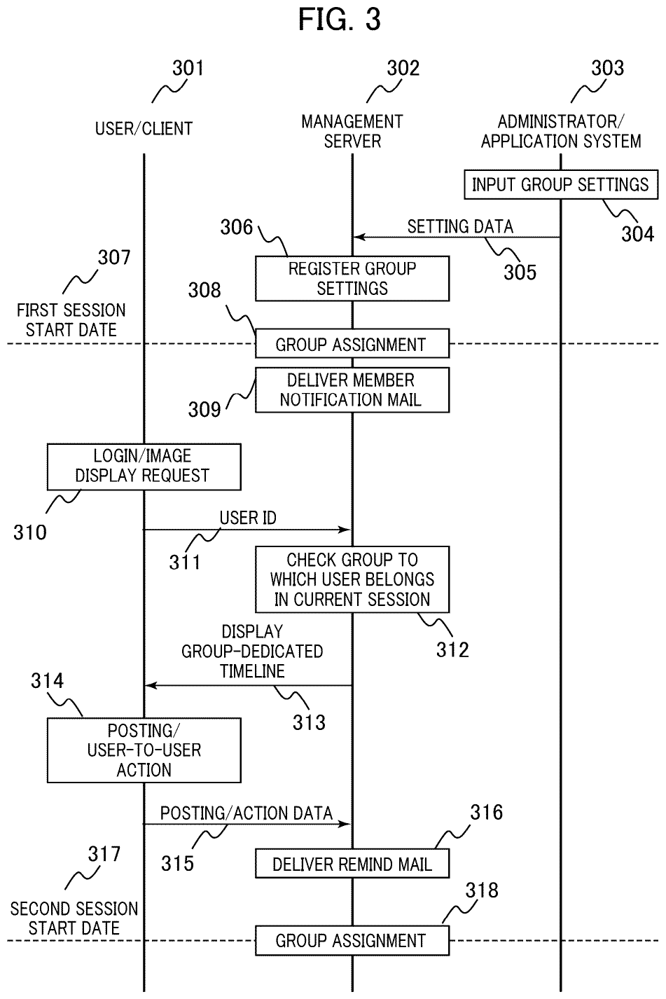

FIG. 3 is a sequence diagram representing a use procedure and an overall flow of processing in the communication promotion system.

In the sequence diagram, by assuming that a user and a client operated by the user are each denoted by 301, a management server is denoted by 302, and an administrator and an application system operated by the administrator are each denoted by 303, a brief description will be given of details of processing in each of the targets and data exchange between the targets.

In a step 304, the administrator inputs the group settings (such as the target users to be grouped, the minimum number of members, and setting of the sessions) and, in a step 305, the input group settings are transmitted from the application 303 to the management server 302. In a step 306, the transmitted group settings are stored (registered) in a database within the management server 302.

In the stored group settings, there is data on a first session start date 307 and, with the timing with which the date arrives, a step 308 (the group assignment processing or group generation processing) is performed. In the step 308, the group assignment processing is performed on the basis of the group settings, and the groups to which the individual users belong for the period of the first session are determined. In parallel, a first session end date is also calculated. In a step 309, to each of mail addresses associated with the target users, an electronic mail containing a member composition of the determined group is delivered. Note that a notification of the member composition is not only made by the electronic mail, but may also be displayed directly on a client screen.

In a step 310, the user performs user authentication through the client to log in, and the client issues the screen display request. In a step 311, the user ID is transmitted from the client 301 to the management server 302. In a step 312, the group to which the user belongs during the first session is checked on the basis of the transmitted user ID. In a step 313, post data of the members of the group to which the user belongs is acquired and transmitted to the client 301, and a group-dedicated timeline is displayed.

In a step 314, the user can input a post or perform a user-to-user action such as a “like” action or a “comment” action on a post made by another user with arbitrary timing through the client. The “Post” means, e.g., inputting of a message by a certain user on the assumption that another user views the message or data including the message. The “Post” may also include an image input or specified by the user or another data.

In a step 315, immediately after the user performs the step 314, data on the post and action is transmitted from the client 301 to the management server 302. Note that the step 314 and the step 315 may also be performed by the user a plurality of times.

In a step 316, an electronic mail (remind mail) containing a posting situation of each of the groups is delivered to each of mail addresses associated with the members of each of the groups. Note that the step 316 may also be performed with periodic timing after the first session start date, and the administrator may also make a setting such that, e.g., the mails are delivered at a predetermined time every day.

The step 310 to the step 316 described above may also be repetitively performed a plurality of times within the period of the first session. Then, with the timing with which a second session start date 317 arrives, new group assignment is performed in a next step 318, and the users are assigned to new groups. Thereafter, session start dates arrive the numbers of times set by the administrator, and the same processing is performed during each of the session periods, though the illustration thereof is omitted. Thus, the management server 302 performs the group generation processing every given period. Accordingly, the group composition periodically changes, and it is possible to eliminate bias in the communication network between the users and help build cross-organizational human relations in the organization.

Once a final session end date has passed, it may also be possible that group assignment is no longer performed and the users do not belong to any group.

According to a flow of overall processing as described above, the target user group specified by the administrator is grouped on the basis of the number of constituent members, schedules, and the like specified by the administrator. Each of the users periodically belongs to a group with a new member composition, and it can be expected that communication between the members within the group becomes close due to display of a timeline dedicated to the group, and delivery of electronic mails, and the like.

The group assignment may also be such that, e.g., group assignment for all the sessions is simultaneously performed immediately after the step 306, not with timing with which each session start date arrives as in the present sequence diagram but, when the group assignment is performed in consideration of most recent relations among the users as will be described later with reference to FIG. 12, the group assignment is desirably performed with the timing with which each of the session start dates arrives. In addition, by performing the assignment each time for each of the sessions, it is possible to respond to a midway increase or decrease of the number of the target users and flexibly take measures, such as changing of the number of the groups, according to the number of the target users with timing with which each session start day arrives.

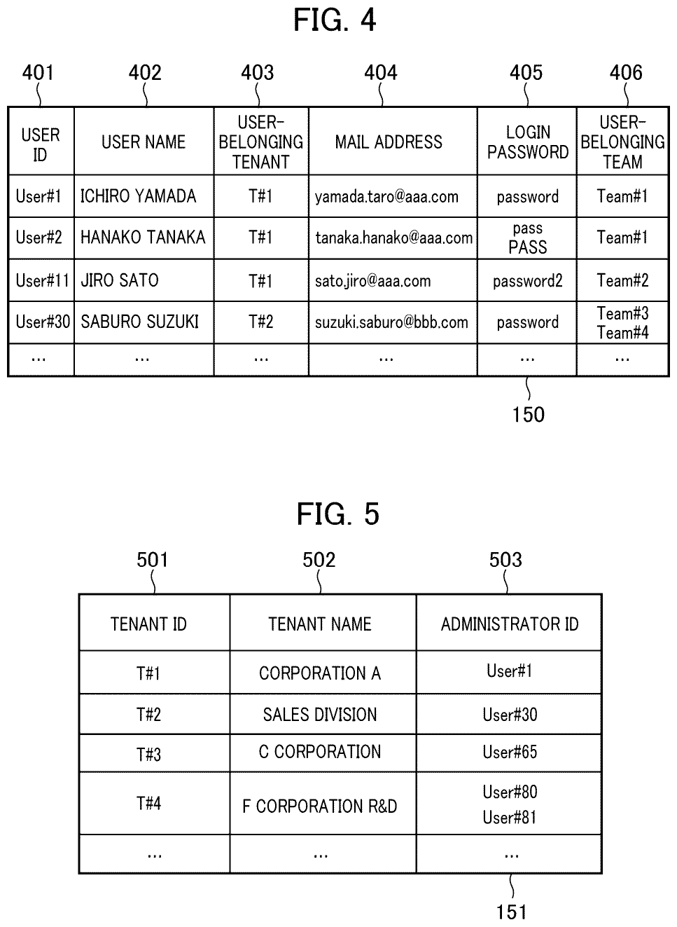

The user table 150 in FIG. 4 is a table that manages user information, and is stored in the storage unit 132 of the management server 130. With a user ID 401, a user name 402, a user-belonging tenant 403, a mail address 404, a login password 405, and a user-belonging team 406 are associated.

The user ID 401 is information to be used to uniquely specify the user in the management server 130. Data to be stored in the user ID 401 can be omitted by specifying any of individual columns used in the present table or a combination of the plurality of columns. Alternatively, the management server 130 may also automatically assign identification numbers in ascending order as identifiers to the individual users. Thus, the storage unit 132 stores the plurality of user IDs specifying the plurality of respective users.

The user name 402 stores the names of the users as information representing the users. The information is displayed on the client 111 or the application system 161 to be used by people to identify the users.

In the user-belonging tenant 403, an ID (corresponding to a tenant ID 501 in FIG. 5) of the tenant to which the user of concern belongs in the tenant table 151 is stored. The tenant is a dedicated region in the system where the individual users belonging thereto can view respective posts made thereby or comment thereon, which are practically set up in units of companies, communities, or the like to which the users belong. The user may also belong to a plurality of the tenants.

The mail address 404 is information to be provided when the user 110 registers an account in the management server 130, which is used as login information in making an access from the client 111 to the management server 130 or used when an electronic mail is delivered from the mail server 134 to the user.

The login password 405 is password information to be used as login information when the user 110 accesses the management server 130 from the client 111.

The user-belonging team 406 is a label to be given to each of the belonging users within the tenant on a per-tenant basis, which is used when the users are classified into given groups on a per-group basis. The user-belonging team 406 can be used as a unit corresponding to the target user group 200 (FIG. 2) serving as a source when the users are assigned to the groups. By assigning the users to the groups on a per user-belong-team basis, when, e.g., there is a combination of the user groups not intended to be assigned to the same group, flexible measures can be taken by keeping separate teams to which the individual user groups belong. When all the users belonging to the tenant are intended to be included in the same target user group, all the users may appropriately be allowed to belong to the same team.

Practically, to avoid information leakage between the tenants, the user-belonging team desirably includes only the users belonging to the same tenant. In other words, all of the plurality of users included in the one target user group 200 preferably belong to a specific company (e.g., specific one company). Note that one user may also belong to the plurality of teams.

Note that the user table 150 is an example, and it is preferable to add information required to manage the user information, if any.

The tenant table 151 in FIG. 5 is a table that manages tenant information, and is stored in the storage unit 132 of the management server 130.

The tenant ID 501 is information to be used to uniquely specify the tenant registered in the management server 130. Data to be stored in the tenant ID 501 can be omitted by specifying any of individual columns used in the present table or a combination of the plurality of columns. Alternatively, the management server 130 may also automatically assign identification numbers in ascending order as identifiers to the individual tenants.

A tenant name 502 stores names of the tenants. The information is displayed on the client 111 or the application system 161 to be used by people to identify the tenants.

An administrator ID 503 stores a user ID of a tenant administrator of the tenant. In the administrator ID, the user IDs of the plurality of users may also be registered.

Note that the tenant table 151 is an example, and it is preferable to add information required to manage the tenant information, if any.

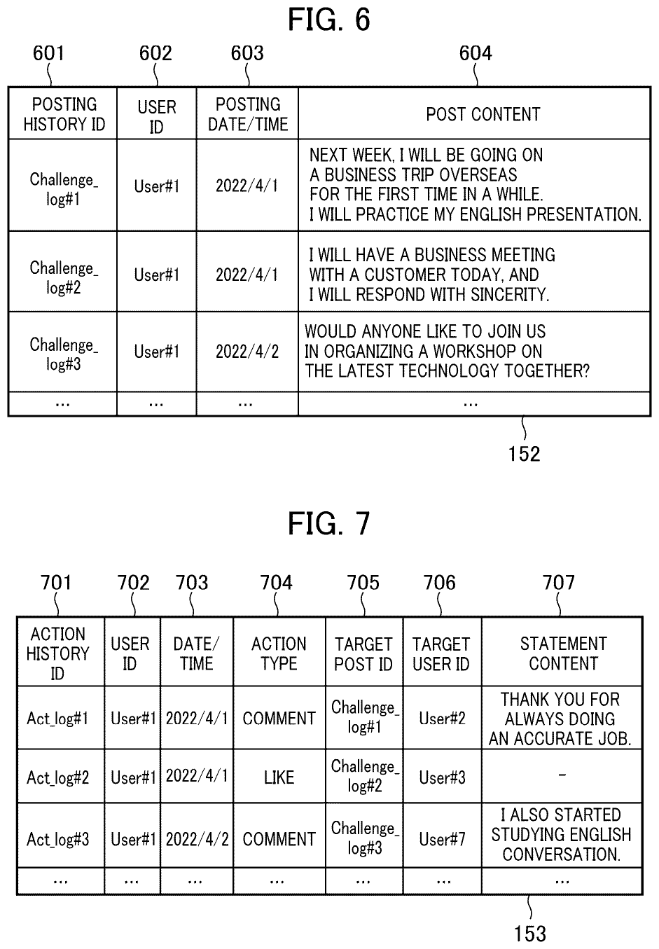

The posting history table 152 in FIG. 6 is a table that manages data of posts made by the users, and is stored in the storage unit 132 of the management server 130.

A posting history ID 601 is information to be used to uniquely specify data representing posts stored in the management server 130. Data to be stored in the posting history ID 601 can be omitted by specifying any of individual columns used in the present table or a combination of the plurality of columns. The management server 130 may also automatically assign identification numbers in ascending order as identifiers to the individual posting histories.

A user ID 602 stores the user ID corresponding to the client 111 that has transmitted the post data to the management server 130. Note that, in a case of using a configuration in which the clients 111 and the user IDs are not in one-to-one correspondence, by associating the post data with the user ID and transmitting/receiving the post data, it is possible to clarify relations between the posts and the user IDs.

A posting date/time 603 stores a date/time when the client 111 transmitted the post data to the management server 130.

A post content 604 is a character string input by the user 110 via the input/output unit 113 of the client 111, which is data serving as a main part of a post. The UI provision unit 142 acquires the post content 604 from the posting history table 152 and displays the post content 604 on the screen of the client 111 or the like to allow the post to be shared by another user.

Note that the posting history table 152 is an example, and it is preferable to add information required to manage posting history information, if any.

The action history table 153 in FIG. 7 is a table that manages data on actions by the users, and is stored in the storage unit 132 of the management server 130.

An action history ID 701 is information to be used to uniquely specify a user action in the management server 130. Examples of the actions include the “like” action and the “comment” action.

Data to be stored in the action history ID 701 can be omitted by specifying any of individual columns used in the present table or a combination of the plurality of columns. Alternatively, the management server 130 may also automatically assign identification numbers in ascending order as identifiers to the individual action histories.

A user ID 702 stores the user ID of the client 111 that has transmitted the action data to the management server 130. Note that, in a case of using a configuration in which the clients 111 and the user IDs are not in one-to-one correspondence, by associating the action data with the user ID and transmitting/receiving the action data, it is possible to clarify relations between the actions and the user IDs.

An action date/time 703 stores a date/time when the client 111 transmitted the action data to the management server 130.

An action type 704 represents a type of each action performed by the user 110 with respect to another user, such as the “like” or “comment”. An action is one of modes of communication on SNS, and one of objects of the present embodiment is to increase frequencies of these actions and equalize the actions to avoid bias between the specific users.

A target post ID 705 is an ID to be used to specify post data at which an action such as “like” or “comment” is targeted and which corresponds to the posting history ID 601 in the posting history table 152.

A target user ID 706 is a user ID to be used to specify the user who has transmitted the post data serving as the target of the action, and corresponds to the user ID 602 in the posting history table 152.

A statement content 707 is a character string input by the user 110 via the input/output unit 113 of the client 111 and, in a case of the “commenting” action, a main text of a comment is stored therein.

Note that it may also be possible to individually provide a separate table for each of an action type such as the “like” or “comment” and, in that case, a table for “like” need not have a column for the statement content 707. Action types may also include not only actions targeted at posted contents such as the “like” and “comment”, but also actions directly targeted at the users such as transmitting a direct mail or giving a peer bonus. Besides, when there is information necessary to manage information on the action history, it is preferable to add the information, if any.

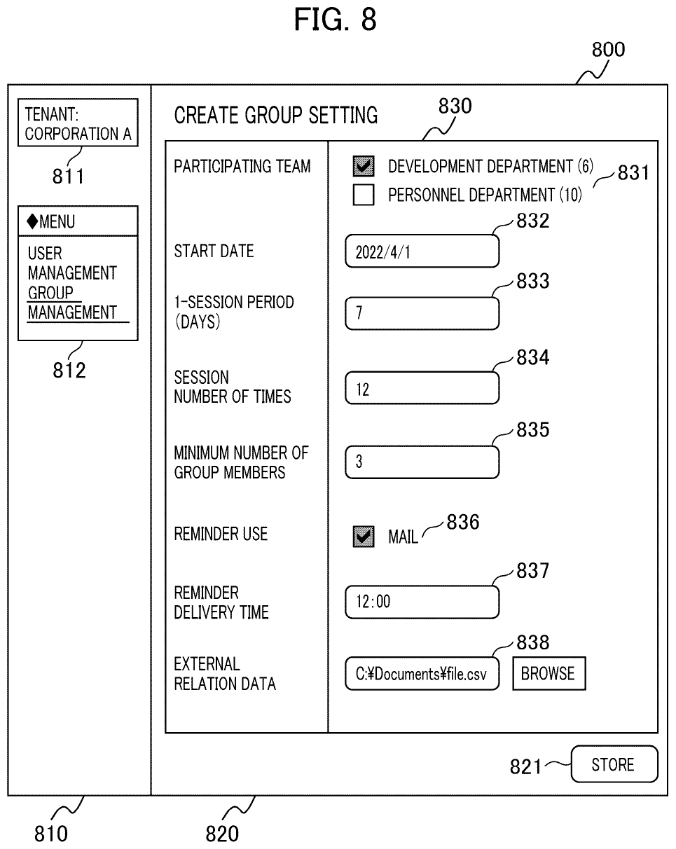

FIG. 8 illustrates an application screen as an example of a GUI for inputting the group settings in the application system 161. On the present screen, the administrator 160 examines the setting of grouping and inputs the setting to the users belonging to the tenant managed by the administrator 160. The inputting is performed in the step 304 in FIG. 3.

An application screen 800 indicates a screen displayed in the application system 161, and is displayed on a display of a PC used by the administrator 160 or the like.

The application screen 800 is divided into a side screen 810 and a main screen 820.

The side screen 810 has a tenant information box 811 and a menu box 812. The side screen 810 displays information which is continuously displayed even when information in the main screen 820 has changed.

The tenant information box 811 displays the tenant names stored in the tenant table 151. This allows the administrator 160 to confirm whether or not an operation can be performed on the tenant to be managed thereby. Besides, it may also be possible to display information on the administrator who has logged in as necessary.

The menu box 812 displays a list of functions that can be performed by the administrator 160 and, as a result of selection among the functions, a transition is made to a screen for using the function. In the illustrated example, the group management is selected. Though the illustration thereof is omitted, in a case of selecting the user management, it may also be possible to display a screen which allows the user to register the tenant or input the setting of the user-belonging team.

The main screen 820 has a create group setting box 830 and a store button 821. The administrator 160 inputs information to the create group setting box 830 and presses the store button 821 to complete the setting of grouping.

The create group setting box 830 has a participating team setting 831, a start date setting 832, a 1-session period setting 833, a session number of time setting 834, a minimum number of group member setting 835, a reminder use setting 836, a remainder delivery time 837, and an external relation data setting 838.

The participating team setting 831 displays a list of teams present within the tenant, and the administrator 160 can select teams as a target of grouping. As long as the following settings are permitted to be common, it may also be possible to select the plurality of teams and make simultaneous settings. Alternatively, the numbers of the members belonging to the individual teams may also be aggregated to serve as a reference when the minimum number of group member setting 835 described later is made.

The start data setting 832 is an item for setting a date of starting assignment of the users to the groups, which indicates the first session start date. It may also be possible that the administrator 160 arbitrarily sets a date after a current date displayed on the present screen. The 1-session period setting 833 is an item for setting a temporal length per session as a given period, which basically specifies the number of days. The session number of time setting 834 is an item for setting the number of times the session is to be repeated. By setting these start date, 1-session period, and the session number of times, a schedule during an entire period during which the grouping is performed is determined.

The minimum number of group member setting 835 is an item for setting the minimum number of the users to be assigned to each of the groups. The effect thereof is as described during the description of FIG. 2, and a relationship with a situation in which the participating team setting 831 is selected is described herein. A desirable set value as the minimum number of group members is about 3 to 5, but the minim number of group members may also be set to any number depending on the situation.

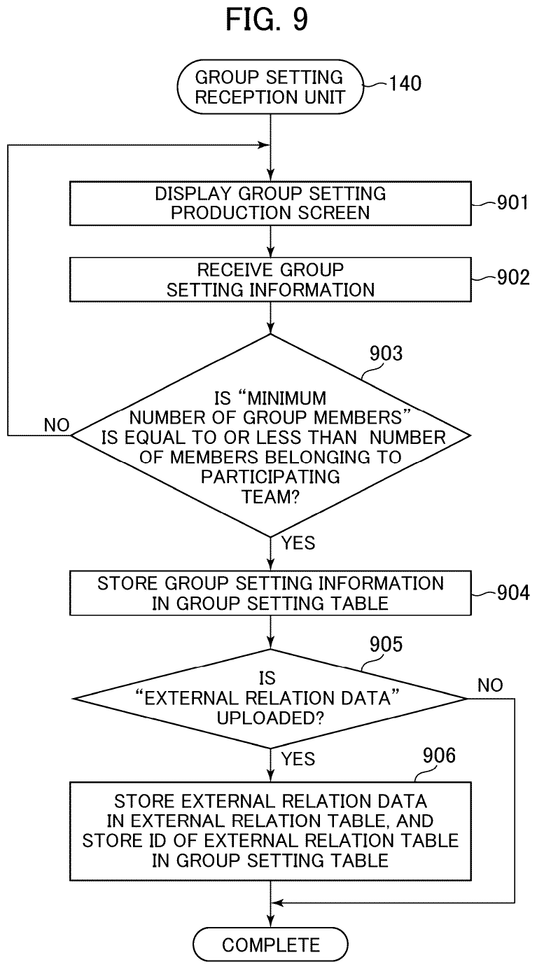

However, due to nature thereof, a numerical value exceeding the number of the members belonging to a participating team cannot be set. Accordingly, it is necessary to limit an inputtable range according to a situation in which the participating team is selected and, by inputting a determination as made in, e.g., a step 903 in FIG. 9, a registration error is desirably determined so as not to set a minimum value exceeding the number of the members belonging to the team.

Thus, the minimum number of group member setting 835 is a predetermined number, which serves as a reference value when the users are assigned to the groups. In other words, the management server 130 assigns the plurality of user IDs to the groups on the basis of the predetermined reference value. Note that, in the present embodiment, a value of the minimum number of the members is specified as the reference value, but the reference value need not be a numerical value directly representing the minimum number of the members, and may also be a value indirectly representing the minimum number of the members. Furthermore, it is also possible to provide any reference value representing a criterion for the number of the members without limiting the value of the minimum number of the members.

The remainder use setting 836 is an item for setting whether or not the user is allowed to receive information even when the user is not in a login state. For example, by selecting the electronic mail, the administrator can determine whether or not a step 309 and a step 316 are to be performed by the mail management unit 146. The remainder delivery time 837 is an item which allows, when it is chosen to make the reminder use setting 836 described above, the delivery time for the electronic mail or the like to be arbitrarily set.

The external relation data setting 838 is an item for arbitrarily specifying a file for the external relation data 180 for considering relationships previously established between the users when the users are assigned to the groups. The specified file is uploaded together with other setting data to the management server 130.

FIG. 9 is a flow chart illustrating an example of processing to be performed by the group setting reception unit 140 of the control unit 131 of the management server 130. The processing is performed in the step 304 to the step 306 in FIG. 3.

The group setting reception unit 140 receives information on the group settings input by the administrator 160 in the application system 161, determines whether or not the information can be registered, and registers the information in the management server 130.

In a step 901, the group setting reception unit 140 displays, in the application system 161, a create group setting screen like the application screen 800 illustrated as an example in FIG. 8. In a step 902, the group setting information input by the administrator 160 is acquired from the application system 161.

In the step 903, it is determined whether or not the value of the minimum number of group members input as the group setting information is not more than the number of the members belonging to the participating team similarly selected as the group setting information. When the minimum number of group members is not more than the number of the belonging members, the processing advances to a step 904, determines a registration error, and returns to the step 901. Note that, when the plurality of participating teams are selected, the number of members belonging to the team including the minimum number of members is used as a determination criterion.

In a step 904, the group setting information is stored in the group setting group 154 to be registered therein. In a step 905, the administrator 160 determines whether or not the external relation data 180 was uploaded at the time of the group setting and, when the external relation data 180 was uploaded, the processing additionally advances to a step 906. In the step 906, the external relation data 180 is stored in the external relation table 157, and the ID thereof is stored (e.g., additionally registered) in the group setting table 154.

Note that it may also be possible to display the already registered group settings on the screen of the application system 161 to allow the administrator 160 to select thereamong and edit or delete what was set.

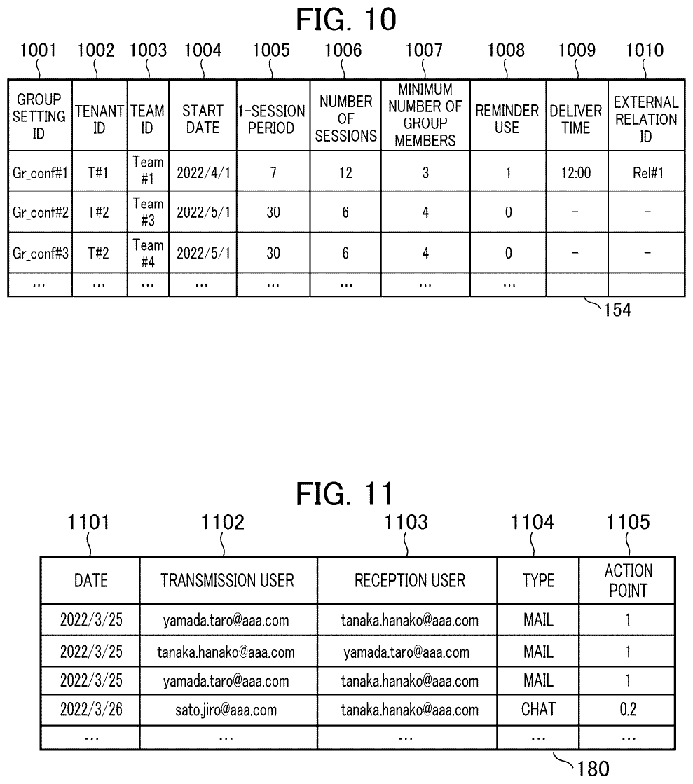

The group setting table 154 in FIG. 10 is a table that manages the information on the group settings registered by the group setting reception unit 140.

The group setting ID 1001 is information to be used to uniquely specify the group settings within the management server 130. Data to be stored in the group setting ID 1001 can be omitted by specifying any of individual columns used in the present table or a combination of the plurality of columns. The management server 130 may also automatically assign identification numbers in ascending order as identifiers to the individual group settings.

A tenant ID 1002 stores the ID of the tenant at which the current group setting is targeted. A team ID 1003 stores the ID of the team at which the current group setting is targeted. The team ID may also include a plurality of the team IDs. A start date 1004 stores a start date of the first session of the current group setting. A one session period 1005 stores, as the given period, the number of days in each one of the sessions of the current group setting. The number of sessions 1006 stores the number of times the sessions of the current group setting are to be repeated. A minimum number of group members 1007 stores, as a reference value for the number of the members belonging to each of the groups in the current group setting, a set value of the minimum number of members. A reminder use 1008 stores a flag value indicating whether or not the reminder is to be used in the current group setting. A delivery time 1009 stores a scheduled delivery time of reminder mails or the like in the current group setting. An external relation ID 1010 is an ID for uniquely specifying the external relation data to be used in the current group setting, which is used as a key when information is associated with the external relation table 157.

FIG. 11 illustrates an example of a data format for the external relation data 180 to be uploaded in the external relation data setting 838 on the application screen 800. A description is given herein using data based on a transmission/reception history of electronic mails or chat messages.

A date 1101 represents an electronic mail or chat message transmission date. A transmission user 1102 is a mail address from which an electronic mail or a chat message is transmitted, while a reception user 1103 is a mail address to which the electronic mail or chat message is transmitted. By checking each of the transmission user 1102 and the reception user 1103 against the mail address 404 stored in the user table 150, it is possible to associate each of the transmission user 1102 and the reception user 1103 with the user ID inside the communication promotion system.

A type 1104 is information presenting the relationships among the users or a content of communication, and represents, in the example in FIG. 11, which record is a history of an electronic mail and which record is a history of a chat message. An action point 1105 is an example of a point to be given to the type 1104, which may also be arbitrarily set by the administrator 160 or the like. By aggregating the action points 1105 during the given period, it is possible to quantify relationships and an amount of communication among the individual users outside the system and allow the resulting quantities to be used for the group assignment processing.

FIG. 12 is a flow chart illustrating an example of processing in the group management unit 141, which is performed in the control unit 131 within the management server 130 with timing with which the start date of each of the sessions arrives. The processing is performed in the step 308 and the step 318 in FIG. 3.

The group management unit 141 performs processing of assigning the target users to the groups on the basis of the information registered in the group setting table 154.

In a step 1201, the number of the groups in the session and the session end date are calculated on the basis of the target group setting registered in the group setting table 154. As illustrated in FIG. 2, the number of the groups is determined such that the number of the members belonging to each of the groups is not less than the value of the minimum number of group members and the number of groups is maximized. As an example of a calculation method, a method of tallying the number of the members belonging to the target team, dividing the number by the value of the minimum number of group members, and using an integer part or quotient can be considered. For example, when the number of the team members is eight and the minimum number of group members is 3, 8/3≈2.66 is calculated, and 2 as the integer part or quotient becomes the number of the groups.

In addition, since the number of the groups is calculated on the basis of the number of the members belonging to the target team at the time of the session start date, it is possible to flexibly respond to a case where the number of the members belonging to the target team increases or decreases immediately before. In the previous example, when the number of the team members increases by 1 to become 9, as a result of calculating 9/3=3, the number of the groups becomes 3 and, when the number of the team members conversely decreases to become 5, as a result of calculating 5/3≈1.66, the number of the groups becomes 1.

Thus, even when the target user is added or excluded after the group setting is registered by the administrator 160, the management server 130 can automatically respond thereto. Note that, when the number of the groups is calculated to be 0 as a result of the decrease of the number of the members belonging to the team, it may also be possible to end the group assignment processing at that time and display a notification on the screen of the application system 161.

The session end date can be calculated by using the value of the one session period stored in the group setting table 154. When calculated, the number of the groups and the session end date are stored in the group table 155.

In a step 1202, a step 1203, and a step 1204, for the target user group to be assigned to the groups, a relation matrix representing a relationship between the target users during a specific period is calculated.

The relation matrix is an example of user relation information representing a relation between the users. The relation matrix is an n×n matrix representing a relation value between each two of the n target users. To the individual rows and the individual columns, the target users are sequentially assigned and, when a relation value between a user #i and a user #j is, e.g., m, as an i-row/j-column element in the relation matrix, m is filled in.

The relation matrix is calculated as each of two types which are an internal relation matrix M1 representing the relationships among the target users inside the communication promotion system and an external relation matrix M2 representing the relationships among the target users outside the system, and a matrix resulting from integration (e.g., addition) thereof is assumed to be an overall relation matrix.

The internal relation matrix M1 is generated by aggregating user-to-user achievements inside the system of the target user group during a valid period T1. The user-to-user achievements may be targeted at, e.g., the number of times “likes” and “comments” are sent, the number of times the users belonged to the same group in the past, or the like, and can be determined by acquiring information items on the two target users from the action history table 153 or the group member table 156 and aggregating the acquired information items. It can be considered that, as the number of the achievements between the two users is larger, the relationship between the users is strong.

In the step 1202, in all pairs of two users in the target user group, the individual user-to-user achievements during the valid period T1 are aggregated and added up to calculate a relation value between the users. Note that the user-to-user achievement may also be weighted depending on the type thereof and, by preparing, e.g., a correspondence table 1210 or the like, not a frequency of each action, but a total value of points defined for each action may also be used as the relation value.

The correspondence table 1210 may be automatically defined in advance inside the system to be held, or may also be able to be defined or changed by the administrator 160. The valid period T1 may be specified by the number of days such as “most recent 7 days” and, for group assignment for the second or subsequent session, the previous session period may also be specified as the valid period T1. By effectively using the internal relation matrix M1 generated as described above, it is possible to determine next group assignment in consideration of a frequency of communication between the users in a period immediately before or the like.

The external relation matrix M2 is generated by aggregating data representing relationships in the target user group outside the system during a valid period T2. When the administrator 160 uploaded the external relation data 180 at the time of the registration of the group settings, the external relation matrix M2 can be calculated on the basis of these information items. In a step 1203, a total value of the action points 1105 in the external relation table 157 during the valid period T2 in all the pairs of the two users in the target user group may also be tallied.

Note that the valid period T2 may be a specific period specified by date or may also be specified in days such as a “latest history for 30 days”. By effectively using the external relation matrix M2 generated as described above, even in a scene in which the target user group uses the communication promotion system for the first time, it is possible to presume already established relationships among the users from data such as an electronic mail transmission/reception history or a face-to-face history and use the presumed relationships to determine the group assignment.

The overall relation matrix is a sum total of the internal relation matrix M1 and the external relation matrix M2 resulting from integration (e.g., addition) thereof. In the step 1204, the individual elements of M1 and M2 are added up, and the resulting sum is output as the overall relation matrix. Note that a calculation method is not limited to the adding up, and the overall relation matrix may also be calculated by weighting the elements and summing the weighted elements or inputting the elements to a specific calculation formula.

By way of example, the overall relation matrix is represented in such a format as that of a relation value table 1211. #1 to #6 represent the target users, while the other elements represent the relation values between the two respective target users. Note that, in the representation in the relation value table 1211, when each of the values of the elements is 0, display thereof is omitted. By effectively using the overall relation matrix generated as described above, it is possible to determine the group assignment in general consideration of the relationships within and outside the system.

Subsequently, in a step 1205 to a step 1209, an example of specific processing of assigning the target user group to the groups is shown. However, an assignment method is not limited thereto.

In the step 1205 to the step 1208, a plurality of group assignment patterns are produced, resulting in repeated processing.

In the step 1206, one user is selected at a time from the target user group and randomly assigned to any of the groups generated in the step 1201 that has the minimum number of members belonging thereto. By performing the assignment with respect to all the users, it is possible to determine a member composition, while reducing variation in the number of the members belonging to each of the groups. The group assignment at this stage is stored as one of the patterns in the memory, but is neither officially adopted yet nor stored in the group member table 156.

In the step 1207, the assignment is evaluated on the basis of each of the overall relation matrix generated in the step 1205 and the pattern of the group assignment generated in the step 1206. By way of example, an assignment pattern 1212 in FIG. 12 will be described. In the assignment pattern 1212, users #1, #2, and #6 are assigned to the same group 1, while users #3, #4 and #5 are assigned to a group 2 as another group. When this state is established, the assignment pattern is evaluated on the basis of a given policy, and an evaluation value is output.

For example, when evaluation is performed with the view to periodically performing group reassignment and thereby eliminating bias in communication, it is desirable to evaluate, as excellent assignment, a pattern in which the users having a small relation value therebetween are assigned to the same group if possible. According to a simple method, among pairs of members belonging to the same group, those each having a relation value which is less than a threshold therebetween are counted, and the resulting count value is used as an evaluation value to thereby allow whether or not the users having little communication therebetween are assigned to the same group to be evaluated.

In the example illustrated in the assignment pattern 1212 in FIG. 12, the users having the relation values which are not less than the threshold are represented by being linked to each other. Under this condition, (#1, #6), (#2, #6), (#3, #4), (#3, #5), and (#4, #5) are not linked, and the number of pairs less than the threshold, which is 5, can be used as the evaluation value.

The steps 1206 and 1207 described above are repeated N times (where N is an integer of not less than 1, which is preferably an integer of 2 or more), and N pairs of the assignment patterns and the evaluation values are output. In the step 1209, the assignment pattern having the largest evaluation value from among the evaluation pattern described above is adopted, and the group assignment is stored in the group member table 156.

Thus, the management server 130 acquires the relation matrices (user relation information), and the group generation processing is performed on the basis of the acquired relation matrices. In particular, through the foregoing processing from the step 1205 to the step 1209, it is possible to preferentially assign the users having little communication therebetween to the same group and efficiently eliminate bias in the communication within the organization.

However, in the step 1207, the group assignment may also be performed by another method. For example, it may also be possible to use a method of totaling the relation values within each of the groups instead of counting the number of the pairs each having the relation value which is less than the threshold, comparing the resulting sums on a per assignment pattern basis, and adopting the assignment pattern with the minimum sum. In addition, it may also be possible to increase evaluation indices from a new viewpoint in addition to an evaluation index aimed at eliminating the bias in the communication. For example, it may also be possible to count the pairs of the users which were in the same group in the previous session and are continuously in the same group in the current session, use the resulting count value as the evaluation index, and adopt the assignment pattern having a smaller evaluation index.

There may also be an index such that assignment which increases user connection triangles is evaluated. For example, in the example of the assignment pattern 1212, it can be said that the users #1 and #6 are in a state where a value of a direct relation value therebetween is low, but each of the users #1 and #6 has a high relation value with the user #5, and the users #1 and #6 have common acquaintances. In such a case, there may also be an index such that, by considering that communication between the users #1 and #6 is more likely to be activated than normal, a state where the users #1 and #6 are in the same state is highly evaluated. When there are a plurality of evaluation indices as described above, it may also be possible to finally total the plurality of evaluation indices and uses the resulting sum as a general evaluation index.

To sum up, since the group management unit 141 determines the number of the groups in each of the sessions on the basis of the number of the members belonging to the team at the time of the start date of the current session, it is possible to flexibly respond to an increase/decrease of the number of the members belonging to the target team. In addition, by considering the relationships among the users on the basis of the user action history or the like and further presuming the relationships outside the system by using external data, it is possible to determine new group assignment depending on an amount of previous communication. At the time of the group assignment, by preferentially assigning, e.g., the users having little communication therebetween to the same group, it is possible to efficiently eliminate the bias in the communication within the organization.

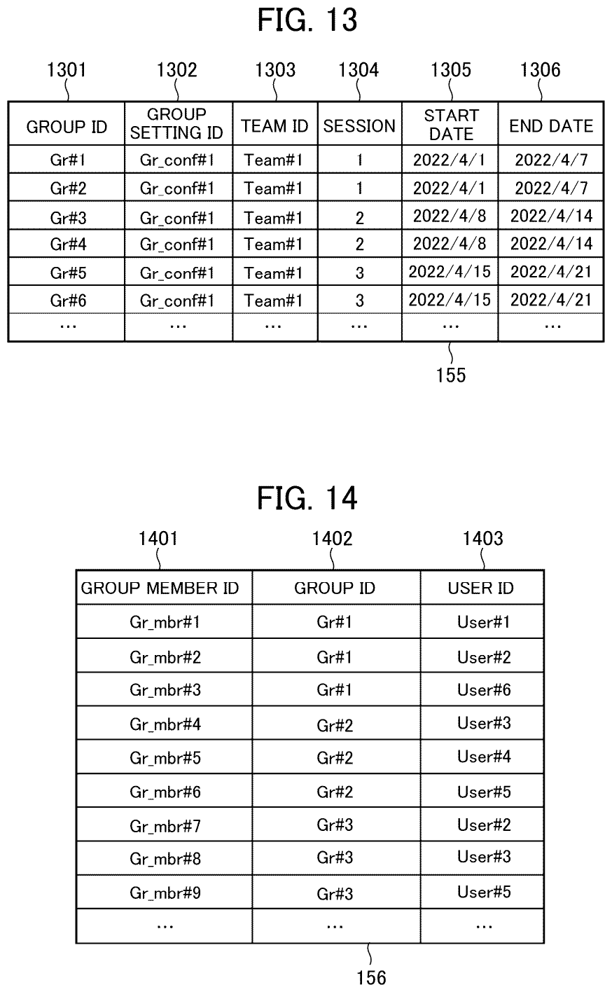

The group table 155 in FIG. 13 is a table for managing the number of the groups and the session periods in the individual group settings, which are registered by the group management unit 141.

A group ID 1301 is information to be used to uniquely specify the group within the management server 130. Data to be stored in the group ID 1301 can be omitted by specifying any of individual columns used in the present table or a combination of the plurality of columns. Alternatively, the management server 130 may also automatically assign identification numbers in ascending order as identifiers to the individual groups.

A group setting ID 1302 is an ID to be used to uniquely specify the group setting as a setting source of the target group, and corresponds to the group setting ID 1001 in the group setting table 154.

A team ID 1303 is an ID to be used to uniquely specify a team to which the user group to be assigned to the target group belongs. A session 1304 represents the number of the session in which the target group performs an activity. A start date 1305 represents a start date of a period during which the target group performs the activity. An end date 1306 represents an end date of the period during which the target group performs the activity.

The example illustrated in FIG. 13 means that, for the group having the group setting ID which is Gr_conf #1, two groups Gr #1 and Gr #2 are generated in the first session. Likewise, in the second session, Gr #3 and Gr #4 are generated while, in the third session, Gr #5 and Gr #6 are generated.

The group member table 156 in FIG. 14 is a table for managing the member composition of each of the groups to be registered by the group management unit 141.

A group member ID 1401 is information to be used to uniquely specify a group member within the management server 130. Data to be stored in the group member ID 1401 can be omitted by specifying any of individual columns used in the present table or a combination of the plurality of columns. The management server 130 may also automatically assign identification numbers in ascending order as identifiers to the individual group members.

A group ID 1402 is an ID to be used to uniquely specify the group to which the garget group member belongs, and corresponds to the group ID 1301 in the group table 155.

A user ID 1403 is an ID to be used to uniquely specify the target group member, and corresponds to the user ID 401 in the user table 150.

In the example illustrated in FIG. 14, to the group having the group ID which is Gr #1, three users belong as the group members. By associating the group ID 1402 with the group ID 1301 in the group table 155, it is possible to acquire information on the member composition and the activity period of each of the groups.

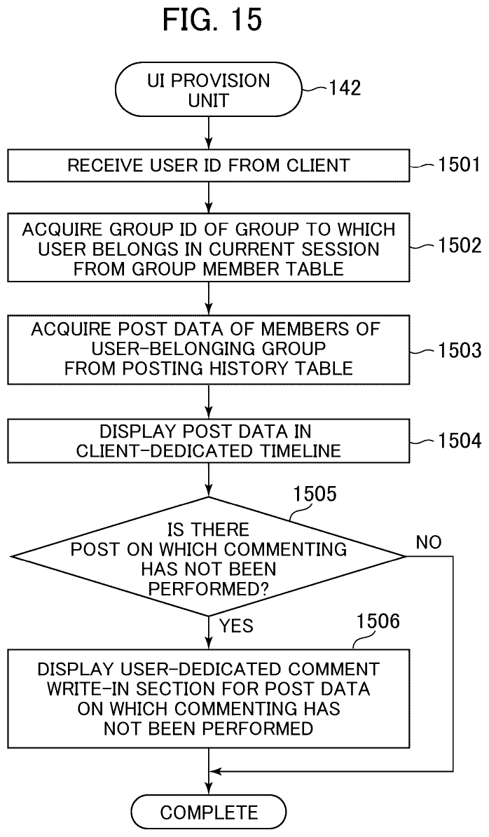

FIG. 15 is a flow chart illustrating an example of processing performed in the UI provision unit 142 of the control unit 131 of the management server 130. The processing is performed from the step 311 to the step 313 in FIG. 3.

The UI provision unit 142 determines the group to which the user belongs in the current session in response to the screen display request from the client and displays the group-dedicated timeline and comments.

In a step 1501, the screen display request transmitted from the client 111 is received by the management server 130. With the screen display request, one of the user IDs (e.g., the user ID of the user who has performed login processing in the client 111) is associated.

In a step 1502, the management server 130 specifies the group to which the user ID belongs on the basis of the one user ID received thereby. For example, the user ID received in the step 1501 is checked in the group member table 156 to allow the group ID to which the user belongs to be acquired.

In a step 1503, post data of all the users belonging to the group specified in the step 1502 is acquired by filtering from the posting history table 152. In a step 1504, the post data acquired in the step 1503 is displayed in the group-dedicated timeline of the client 111.

Thus, the client 111 displays the timeline according to the group and the user ID. In particular, in the present embodiment, the client 111 displays a different timeline depending on the group. This promotes efficient communication specifically to a limited group.

In a step S1505, a person having the user ID received in the step 1501 determines whether or not commenting has already been performed on each of posts displayed in the step 1503 on the basis of the action history table 153. When there is a post on which commenting has not been performed, the processing additionally advances to a step 1506 and displays a user-dedicated comment input field (write-in section) for the post on which commenting has not been performed and which is displayed in the timeline.

Note that, as the post data displayed in the step 1504, only data posted during a target period which is limited to the current session may also be displayed. Additionally, as the post data that displays the user-dedicated comment input field displayed in the step 1506, only the data posted during the target period which is limited to the current session may also be displayed.

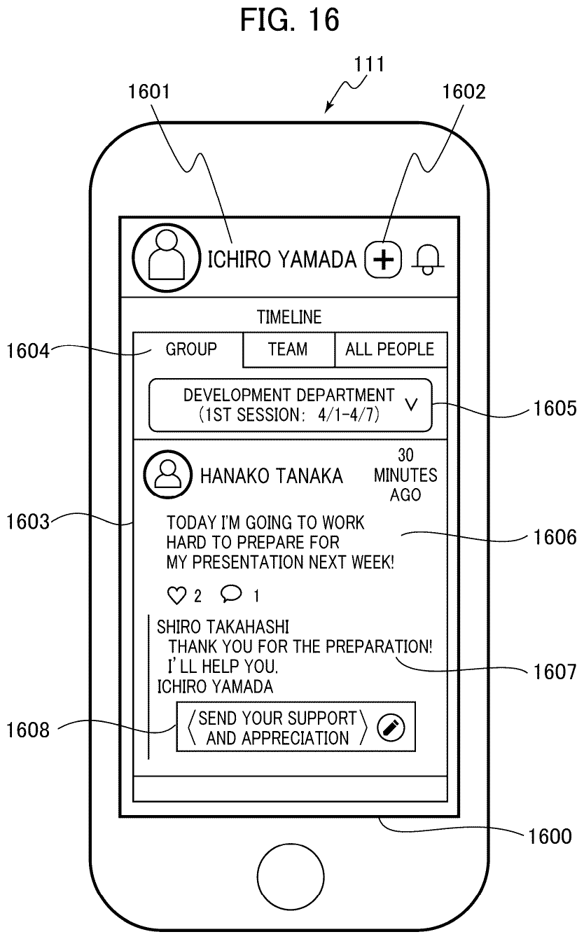

FIG. 16 illustrates an example of a GUI (client screen) showing an example of the group-dedicated timeline and the user-dedicated comment input field which are displayed on the screen of the client 111.

On the present screen, the user 110 posts or comments on a post made by another person. A part of the present screen is displayed by the UI provision unit 142 through steps as illustrated in FIG. 15.

A client screen 1600 is an example of a screen displayed after user authentication, and has a login user name 1601, a posting button 1602, and a timeline 1603. The login user name 1601 is information displaying a user name associated with the user ID subjected to the user authentication and representing the user. A posting button 1602 is a button to be pressed when the user 110 who has logged in uses the posting function 117 and, in response to pressing of the posting button 1602, a post production screen or the like is displayed.

The timeline 1603 displays data posted by the user (the user who has logged in or another user). The timeline 1603 includes one or more posts 1606. The timeline 1603 also includes, for each of the posts, a name of the poster (an example of the information representing the user), a post content, a posting time, the number of times a “like” action is performed on the post, and the number of comments made on the post. When there is a comment, the timeline 1603 includes, for each comment, a name of the commenter (an example of the information representing the user) and a content of the comment. The user 110 can view a post made by another user via the timeline 1603 and perform the user-to-user action such as the “like” action or the “comment” action.

Specific processing for performing “post”. “like”, and “comment” can appropriately be designed by a person skilled in the art on the basis of a known SNS technology or the like. By way of example, the client 111 receives an input sentence as the post content, and transmits the information illustrated in FIG. 6 (except for the posting history ID 601) to the management server 130. As illustrated in FIG. 6, the post is associated with the user ID.

The management server 130 receives the information, adds the posting history ID 601 thereto, and stores the information. In addition, the management server 130 transmits the content of this post in response to the screen display request from the client, and the client 111 of each of the users displays the content of the post in the timeline 1603. Thus, the management server 130 receives the post associated with the user ID, generates the timeline on the basis of the post, and causes the client 111 to display the timeline. The post from each of the users is thus reflected on the timeline and displayed to promote communication.

When the content of the post made by another user is thus displayed on the screen of the client 111 and when a certain user is favorably impressed with the post, by performing a given “like” action (e.g., an operation of clicking a predetermined region), the user can input evaluation of the favorable impression to the client 111. In response to the “like” action, the client 111 transmits the information illustrated in FIG. 7 (except for the action history ID 701) to the management server 130. The management server 130 adds the action history ID 701 to the information and stores the information.

When transmitting the content of the post to the client 111, the management server 130 refers to the action history table 153, acquires information on the “like” action with respect to the post, calculates the total number of the “like” actions, and transmits the total number together with the content of the post. The client 111 that has received this displays the total number of the “like” actions in association with the post when displaying the post in the timeline 1603.

A group tab 1604 is a button for changing a display range for the timeline 1603, and is used particularly for a change to a group-dedicated timeline which displays only posts made by members of the group to which the user 110 belongs.

When the group tab 1604 is selected, the post 1606 displayed in the timeline and a user-dedicated comment input field 1608 are provided by the UI provision unit 142. In addition, in association with the comment input field 1608 (immediately above the comment input field 1608 in the example in FIG. 16), the name (the same as the login user name 1601) of the user using the client 111 is displayed. Thus, the client 111 displays, together with the timeline 1603, the information (name) representing the user associated with the user ID and the comment input field 1608 for receiving an input comment.

The “commenting” action can also be designed similarly to the “like” action described above. However, in the “comment” action, the user can use the comment input field 1608 to input a sentence or message as the content of the comment with respect to a post made by another user. In response to the comment action, the client 111 transmits the information illustrated in FIG. 7 (except for the action history ID 701) to the management server 130. The management server 130 adds the action history ID 701 to the information and stores the information. When transmitting the content of the post to the client 111, the management server 130 refers to the action history table 153 to acquire information on a comment made on the post and transmits the information together with the content of the post. The client 111 that has received this displays the content of the comment in association with the post when displaying the post in the timeline 1603.

In association with the comment input field 1608, display which prompts the inputting of a comment may also be performed. For example, when the user has not input a comment on the post yet (i.e., when a comment associated with the user ID associated with the screen display request has not been input), the client 111 displays a message which prompts the inputting of a comment in association with the comment input field 1608. In the example in FIG. 16, the message “<Send your support and appreciation>” corresponds thereto. By performing such display, it is possible to promote communication between the users.

Note that, in addition to the group tab 1604, a tab for changing to a timeline in which a post from a user belonging to the team to which the user 110 belongs can be viewed or a tab for changing to a timeline in which a post from a user belonging to the tenant to which the user 110 belongs can be viewed may also be provided. When the user 110 does not belong to any group, it may also be possible to render the group tab 1604 unselectable or hide the group tab 1604.

A group selection pulldown 1605 is used by the user 110 to filter the post data displayed in the group-dedicated timeline. For example, when the user 110 belongs to a plurality of the teams and the group settings are registered in each of the teams, it follows that the user 110 belongs to the plurality of groups. Accordingly, when only posts from a specific group are intended to be viewed, a pulldown in which the team name and the session period are displayed is selected to allow the posts from the group to be displayed.

Each of the posts 1606 may also be configured to include the name of the user who has made a post, information related to posting timing, and a posted sentence. In the timeline 1603, the posts 1606 are displayed in order of most recent posting date/time first. A comment 1607 displays a content of a comment made by another user on the post.

The user-dedicated comment input field 1608 is an item displayed by the UI provision unit 142, and is displayed when the user 110 has not commented on a post made by a group member. By way of example, the name of the user 110 is displayed in advance and, in a section where a comment made by the user 110 is displayed, such a message as to prompt commenting is displayed.

In the present embodiment, whether or not the comment input field 1608 is to be displayed is dynamically determined. When the user 110 has already input a comment on the post (i.e., when a comment associated with the user ID associated with the screen display request has already been input), the client 111 does not display the comment input field 1608. Thus, only when no comment has been input, communication can efficiently be promoted.

In addition, such display of the timeline dedicated to the group to which the user belongs allows the target users with which the user should exchange comments to be easily recognized to facilitate viewing of posts made by the target users. Furthermore, when commenting has not been performed, accentuated display of the user-dedicated comment input field allows the user to easily recognize that commenting has not been performed, and it can be expected to promote writing of a comment.

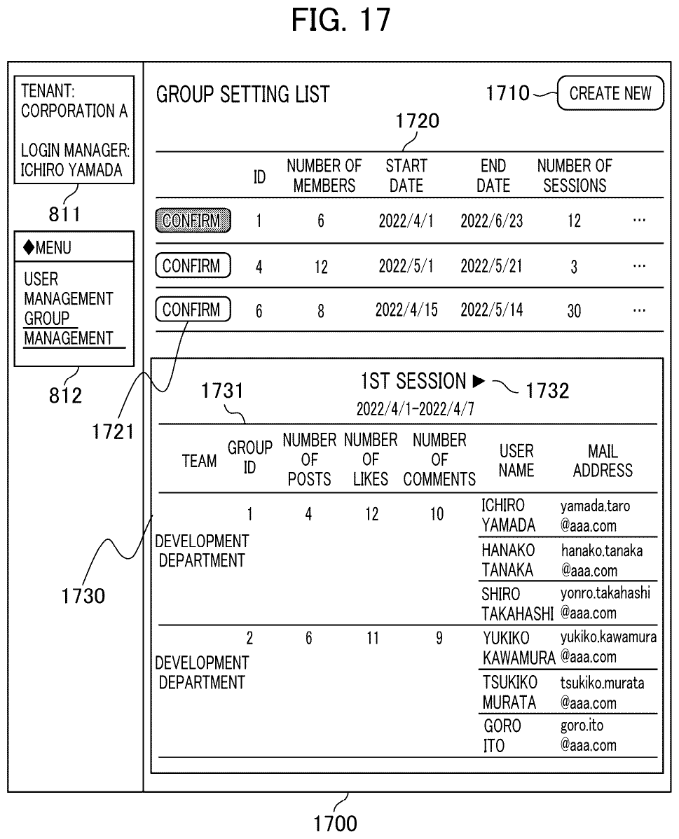

FIG. 17 illustrates an application screen as an example of the GUI for checking a group setting situation in the application system 161. On the present screen, the administrator 160 checks a list of the group settings made in the tenant managed thereby and a group situation in each of the settings.

A main screen 1700 is configured to include a create new button 1710, a group setting list 1720, and a group detailed information box 1730.

The create new button 1710 is a button to be pressed by the administrator 160 when newly creating group settings and, in response to the pressing thereof, the screen changes to the main screen 820 in FIG. 8.

The group setting list 1720 displays a list of the created group settings to allow contents of the settings to be confirmed. For example, IDs of the corresponding group setting, the number of participants, the start date, and the end date are displayed. When the management server 130 receives the screen display request from the application system 161, the group situation provision unit 145 acquires and displays information such as the group setting table 154. Each of the group settings may also be able to be edited or deleted.

A confirm detail button 1721 is a button for confirming a situation in which the group settings have been made and, by placing any of the group settings in a selected state, the group detailed information box 1730 is displayed.

The group detailed information box 1730 has a group situation list 1731 and session information 1732. The group situation list 1731 displays information such as the member composition of each of the groups and the number of comments in any of the group settings. In the group situation list 1731, the management server 130 displays, for each of the groups, a total number of posts from the group (more strictly, posts related to the user IDs belonging to the group) and a total number of comments made on these posts. Alternatively, a total number of “likes” given to these posts may also be displayed.

When the management server 130 receives the screen display request from the application system 161, the group situation provision unit 145 aggregates these information items from the group member table 156, the action history table 153, and the like and displays the aggregated information items. The session information 1732 represents the session serving as a target period of the information displayed by the group situation list 1731. It may also be possible to select another session, and change the information displayed in the group situation list 1731 in response thereto.

By displaying these information items on the screen, the administrator can use the information items to review the group settings or recognize a degree of promotion of communication on in each of the groups.

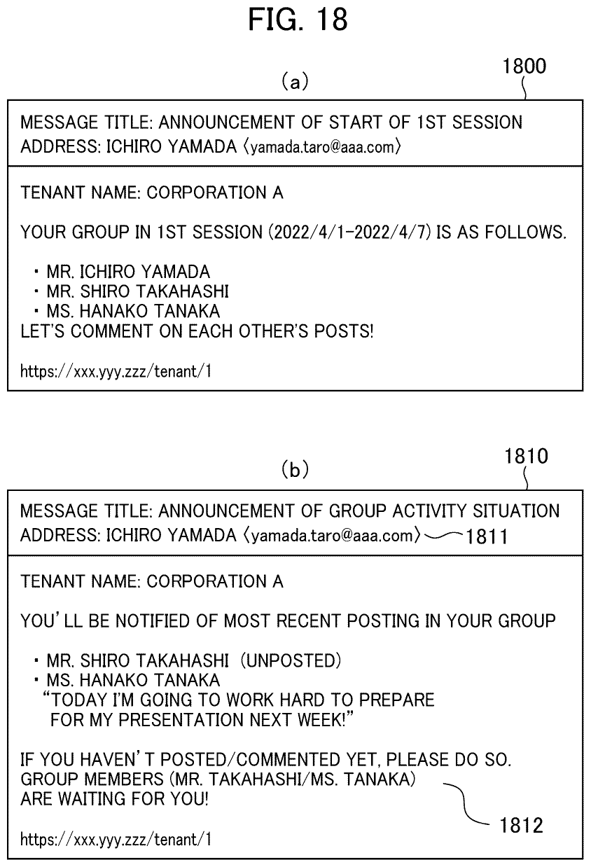

FIG. 18 are diagrams illustrating an example of electronic mails delivered to each of the users belonging to the group in each of the sessions. The electronic mail is delivered when the electronic mail is chosen in the reminder use setting 836 in FIG. 8.

A member notification mail 1800 illustrated in FIG. 18(a) is an example of an electronic mail which notifies each of the users belonging to each of the groups of a member composition after the group assignment is performed. The member notification mail 1800 is delivered in the step 309 in FIG. 3, and the mail management unit 146 acquires group member information in the current session on the basis of the information in the group table 155 and the group member table 156. For each of the groups, the mail management unit 146 uses the electronic mail to the mail address associated with each of the user IDs belonging to the group to transmit information (e.g., name) representing the user associated with each of the user IDs belonging to the group.

Thus, even in a non-login state, the user can know the group member composition in the current session with timing of the session start date or the like, and can raise awareness of communication with the group members.

A remind mail 1810 illustrated in FIG. 18(b) describes a member posting situation of the group to which the user belongs. The remind mail is an electronic mail delivered in the step 316 in FIG. 3, and the mail management unit 146 acquires information on the posts made by the group members on the basis of the information in the group member table 156 and the posting history table 152.

A post mail main text 1812 may also has a different sentence depending on a destination address user 1811 or the presence or absence of a most recent post made by a group member. For example, for each of the groups, the mail management unit 146 uses the electronic mail to the mail address associated with each of the user IDs belonging to the group to transmit information representing whether or not a post associated with each of the user IDs belonging to the group is made within a given period. The “within the given period” may also mean, e.g., within a period after the group generating processing was performed up to a current time. The example in FIG. 18(b) shows that a person named Shiro Takahashi has not performed posting yet, while a person named Hanako Tanaka has already performed posting. This allows the user who has not performed posting to be aware of no posting and can promote posting.

Alternatively, the post mail main text 1812 may also have a message which prompts posting when the destination address user 1811 has not performed posting or may also have a message which requests the group members to speak up when the group members have not performed posting. Thus, even in the non-logged-in state, the user can know a posting situation of the group members, easily self-recognize that he or she forgot to make comments or the like, and promote communication.

As described heretofore, on the basis of the settings registered by the administrator, the user is automatically assigned to the group including the small number of members to have such relations with the group members that the user and the group members send comments to each other through the group-dedicated timeline. By belonging to the group including the small number of members, any user can expect to receive a given number or more of comments from the other members, and concentration on the specific user or the like is less likely to occur. In addition, people to whom comments should be sent are automatically determined and the number of the people is limited, which reduces a burden on a person who sends a comment. By further preferentially reassigning the users who have weak relationships therebetween to the same group on the basis of information on an amount of most recent communication among the individual users, it is possible to efficiently eliminate communication bias in the organization and promote cross-organizational communication.

In the foregoing first embodiment, relations between hardware and functions in each of the computers can be changed as appropriate. A person skilled in the art can appropriately transfer any of the functional units illustrated in, e.g., FIG. 1 to any of the computers illustrated in FIG. 1 or to another computer not shown.

### LIST OF REFERENCE SIGNS

110: User
114: Control unit (processing unit)
115: Storage unit
120: User
131: Control unit (processing unit)
132: Storage unit
164: Control unit (processing unit)
165: Storage unit
200: Target user group (plurality of users)
201: Group
202: Group
210: Minimum number of members (reference value)
220: Group assignment processing (group generation processing)
221: Group assignment processing (group generation processing)
230: First session (given period)
231: Second session (given period)
308: Step (group generation processing)
310: Step (screen display request)
401: User ID
402: User name (information representing user)
403: User-belonging tenant (company)
404: Mail address
602: User ID
702: User ID
833: Setting of 1-session period (given period)
835: Setting of minimum number of group members (reference value)
1005: Setting of 1 session period (given period)
1007: Minimum number of group members (reference value)
1211: Relation value table (user relation information)
1403: User ID
1601: Log-in user name (information representing user)
1603: Timeline
1606: Post
1607: Comment
1608: Comment input field
1800: Member notification mail (electronic mail)
1810: Remind mail (electronic mail)

1. An information processing system comprising a processing unit and a storage unit,
wherein the storage unit stores a plurality of user IDs specifying a plurality of respective users, and
wherein the processing unit performs:
group generation processing of assigning each of the plurality of user IDs to a group on the basis of a predetermined reference value, and a type and frequency of communication;
display of a timeline according to the group and the user ID; and
display of information representing a user related to the user ID and a comment input field for receiving an input comment on another user belonging to the group together with the timeline.

2. The information processing system according to claim 1,
wherein the plurality of users belong to any of a plurality of user-belonging teams, and
wherein the group generation processing is performed individually for each of the user-belonging teams.

3. The information processing system according to claim 1,
wherein the processing unit performs:
reception of a screen display request associated with one of the user IDs;
specification of the group to which the user ID belongs on the basis of the one user ID; and
display of the timeline which differs according to the group.

4. The information processing system according to claim 3,
wherein the processing unit does not display the comment input field when the comment associated with the one user ID has already been input.

5. The information processing system according to claim 3,
wherein, when the comment associated with the one user ID has not been input, the processing unit displays a message which prompts inputting of the comment in association with the comment input field.

6. The information processing system according to claim 1,
wherein the processing unit performs the group generation processing with predetermined timing.

7. The information processing system according to claim 1,
wherein, for each group, the processing unit uses an electronic mail to a mail address associated with each of the user IDs belonging to the group to transmit information representing the user related to each of the user IDs belonging to the group.

8. The information processing system according to claim 1,
wherein the processing unit acquires user relation information representing a relation between the users, and
wherein the group generation processing is performed on the basis of the user relation information.

9. The information processing system according to claim 1,
wherein the processing unit receives a post associated with each of the user IDs to generate the timeline on the basis of the post.

10. The information processing system according to claim 1,
wherein, for each group, the processing unit displays a total number of posts related to the user IDs belonging to the group and a total number of comments made on the posts.

11. The information processing system according to claim 9,
wherein, for each group, the processing unit uses an electronic mail to a mail address associated with each of the user IDs belonging to the group to transmit information representing whether or not the post associated with each of the user IDs belonging to the group is made within a given period.

12. A program for causing a computer to function as the information processing system according to claim 1.

13. The information processing system according to claim 1,
wherein the information processing system does not display a comment input field for receiving an input comment on a user not belonging to the group related to the timeline.

14. The information processing system according to claim 1,
wherein the processing unit performs the group generation processing of assigning each of the plurality of user IDs to the group on the basis of an achievement of communication between the plurality of users.

15. The information processing system according to claim 1,
wherein the processing unit performs the group generation processing of assigning each of the plurality of user IDs to the group on the basis of an evaluation value obtained by evaluating that a relation value between the plurality of users, which is calculated on the basis of an achievement of communication between the plurality of users, is less than a predetermined threshold.
